(19) United States
(12) Patent Application Publication
(10) Pub. No.: US 2019/0362187 A1
(43) Pub. Date: Nov. 28, 2019

(54) TRAINING DATA CREATION METHOD AND TRAINING DATA CREATION APPARATUS

(71) Applicant: Hitachi, Ltd., Tokyo (JP)

(72) Inventors: Hiroko OTAKI, Tokyo (JP); Kunihiko KIDO, Tokyo (JP)

(21) Appl. No.: 16/363,015

(22) Filed: Mar. 25, 2019

(30) Foreign Application Priority Data
May 23, 2018 (JP) 2018-098361

(51) Int. Cl. G06K 9/62; G06K 9/00; G06N 20/00; G06N 3/08

(52) U.S. Cl. CPC G06K 9/6256; G06K 9/00449; G06N 3/08; G06N 20/00; G06K 9/00456

(57) ABSTRACT

Provided is a training data creation method includes a step to create a training set that includes, as an index term for extracting a document used for learning, one or more of the index terms assigned to applicable documents or non-applicable documents, a step to create the document identification model that learns the document data assigned the index term included in the training set, and create an evaluation value by using the created document identification model to identify prescribed evaluation data, a step to determine whether to use each index term included in the training set for creating the training data on the basis of the evaluation value, and a step to create the training data by adding document data that is assigned an index term determined to be appropriate for use in creating the training data.

### CLAIM OF PRIORITY

The present application claims priority from Japanese patent application JP2018-98361 filed on May 23, 2018, the content of which is hereby incorporated by reference into this application.

### BACKGROUND OF THE INVENTION

The present invention relates to a training data creation method and apparatus for performing document identification by machine learning.

There has been an increase in the number of computerized documents such as newspapers, patents, and academic papers, and there is demand for extracting useful information from such documents. As a measure to address this need, machine learning is employed for large amounts of documents in order to identify documents having useful information therein. The issue in identifying whether or not useful information is included in a document is in creating training data that separates a document group containing useful information from a document group that does not contain useful information from among a document group serving as the parent population for which identification is to be performed, and performing machine learning.

In machine learning, the greater the variation in training data there is, the greater the generalizability is and the higher the accuracy of the results is, and thus, it is necessary to create abundant training data in order to improve accuracy. However, involving people in creating training data incurs a high cost, and results in difficulties in ensuring a wide variation in data. Thus, a method by which data is expanded from a small training data sample is under consideration.

JP 2006-4399 A (Patent Document 1) discloses a technique in which, instead of identifying documents by machine learning, the variation in training data for information extraction is mechanically increased. Specifically, information extraction rules are created from training sample data, and data is expanded through allowable changes in word order, changes to some modifiers, and syntax representation conversion.

### SUMMARY OF THE INVENTION

Regarding the problem to be resolved of document identification, it is not easy to prepare information extraction rules in advance in a manner similar to information extraction itself. Even if such rules were prepared, when expanding data, increasing the variation in data by switching word order, changing some of the modifiers, performing syntax representation conversion, and the like in a manner similar to information extraction enables the properties of the training sample data to be captured, but does not allow for preparation of varied training data for document identification.

The present invention was made in view of the above problems. That is, an object of the present invention is to provide a training data expansion technique for increased accuracy in document identification while suppressing costs for training data creation in document identification.

In order to solve at least one of the foregoing problems, provided is a training data creation method executed by a computer system having a processor and a storage unit, wherein the storage unit stores a plurality of pieces of document data, each of which is assigned one or more index terms, wherein some of the plurality of pieces of document data are training data samples provided in advance as training data to be used for generating a document identification model, wherein the storage unit stores information indicating whether each piece of document data included in the training data sample is data of an applicable document that is subject to identification by the document identification model or a non-applicable document that is not subject to identification, and wherein the training data creation method comprises: a first step in which the processor creates a training set that includes, as an index term for extracting a document used for learning, one or more of the index terms assigned to the applicable documents and the index terms assigned to the non-applicable documents; a second step in which the processor creates the document identification model that learns the document data assigned the index term included in the training set, among a plurality of pieces of document data aside from the training data sample; a third step in which the processor uses the created document identification model and identifies evaluation data including the plurality of pieces of document data that are assigned in advance information indicating whether the document data is the applicable document or the non-applicable document, thereby creating an evaluation value of the created document identification model; a fourth step in which the processor determines whether to use each index term included in the training set for creating the training data on the basis of the evaluation value; and a fifth step in which the processor adds as the applicable document data, to the training data, document data that is assigned an index term of an applicable document determined to be appropriate for use in creating the training data, among the plurality of pieces of document data aside from the training data sample, and adds document data assigned an index term of a non-applicable document determined to be appropriate for use in creating the training data to the training data as the non-applicable document data, to create the training data.

According to one aspect of the present invention, it is possible to expand training data that captures the properties of the training sample created mechanically by people, to a large amount of training data. If a person is to determine which index term to adopt, effort would need to be expended in order to create the training data so as to fit evaluation data, but by mechanically testing various combinations of training data, the search range is widened, and training data that is closer to the training sample data distribution can be created.

Problems, configurations, and effects other than what was described above are made clear by the description of embodiments below.

### BRIEF DESCRIPTION OF THE DRAWINGS

FIG. 1 is a block diagram showing a configuration of a document identification system and a training data expansion apparatus for document identification according to an embodiment of the present invention.

FIG. 2 is a flowchart showing a process executed by the training data expansion apparatus according to an embodiment of the present invention.

FIG. 3 is a flowchart showing a process in which the training data expansion apparatus according to an embodiment of the present invention learns for each training set.

FIG. 4 is a flowchart showing a process by which the training data expansion apparatus according to an embodiment of the present invention determines the index term to use.

FIG. 5 is a descriptive view showing a configuration example of a training data sample retained by the training data expansion apparatus according to an embodiment of the present invention.

FIG. 6 is a descriptive view showing a configuration example of index term-related document group data retained by the training data expansion apparatus according to an embodiment of the present invention.

FIG. 7 is a descriptive view showing a configuration example of training set data retained by the training data expansion apparatus according to an embodiment of the present invention.

FIG. 8 is a descriptive view showing a configuration example of training set evaluation value data retained by the training data expansion apparatus according to an embodiment of the present invention.

### DETAILED DESCRIPTION OF EMBODIMENTS

First, a summary of the present embodiment will be described. As described above, the issue in identifying documents that include useful information is in creating training data that separates a document group containing useful information from a document group that does not contain useful information from among a document group serving as the parent population for which identification is to be performed, and performing machine learning. In order to deal with this issue, first, a sample of training data separated into a document group including useful information and a document group not including useful information is prepared for machine learning. The present invention relates to a means for expanding this training data sample.

In order to expand data while capturing the properties of the training data sample, an index term assigned to each document is used.

An index term is a keyword that summarizes the content of the document, and is sometimes assigned by a person and sometimes assigned by a computer. Index terms are assigned to academic papers, patents, and the like. When documents are searched using an index term, documents having content pertaining to the index term are efficiently gathered.

Each document attained as training data sample is also assigned an index term corresponding to the document. If index terms corresponding to the training data sample are gathered only for text groups including useful information (hereinafter referred to as “applicable document group”), or gathered only for text groups not including useful information (hereinafter referred to as “non-application document group”), then there are index terms common to both the applicable document group and the non-applicable document group, but normally, a unique index term is included for each document group.

If an index term unique to the applicable document group is extracted and documents corresponding to the index term are searched with the found documents being the training data for the applicable document group, while an index term unique to a non-applicable document group is extracted and documents corresponding to the index term are searched with the found documents being the training data for the non-applicable document group, then an expanded data set can be attained while capturing the properties of the training data sample.

However, it is not easy for a person to determine whether a given index term pertains to applicable documents or non-applicable documents. If the index term could be determined to correspond to applicable documents or non-applicable documents, then the document group to which the index term is assigned could be adopted as training data, and training data for applicable documents or non-applicable documents could be created.

First, a list of index terms corresponding to a training data sample determined to be constituted of applicable documents and a list of index terms corresponding to a training data sample determined to be constituted of non-applicable documents are created, index terms common to both applicable and non-applicable documents are removed, and lists of index terms as candidates to be incorporated in the training data are created for the applicable documents and the non-applicable documents, respectively.

Next, combinations of index terms for the applicable documents and non-applicable documents are randomly generated from the candidate index term list. A prescribed number of index terms and combinations are created, thereby forming a training set list.

One set is acquired from the training set list storing the combination of index terms, and a document group pertaining to the index term in the list is acquired, thereby creating the training data.

An identification device of documents is created from the created training data, and evaluated using evaluation data.

Such evaluation is repeated, and an index term used when the evaluation value exceeds a predetermined baseline is adopted as the index term to be used in the training data and final training data is created from the adopted training data, thereby identifying documents.

An embodiment will be explained below with reference to the drawings.

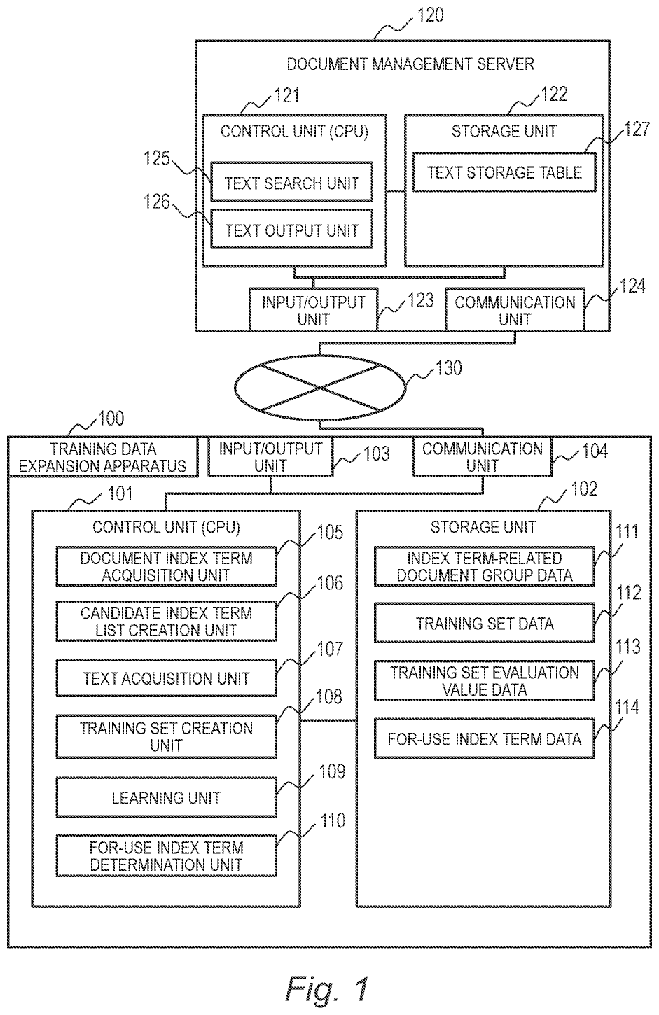

FIG. 1 is a block diagram showing a configuration of a document identification system and a training data expansion apparatus for document identification according to an embodiment of the present invention.

The document identification system of the present embodiment is constituted of a training data expansion apparatus 100 and a document management server 120 connected to each other through a network 130.

The training data expansion apparatus 100 is constituted of a control unit 101 and a storage unit 102, an input/output unit 103, and a communication unit 104 that are connected to the control unit 101. As will be described later, the training data expansion apparatus is an apparatus that expands training data (or in other words, creates expanded training data) by adding, to an inputted training data sample, documents that can be used as training data to identify which of the documents are applicable documents and non-applicable documents.

The control unit 101 is a processor (central processing unit; CPU) that executes various processes according to programs (not shown) stored in the memory 102. The control unit 101 of the present embodiment has a document index term acquisition unit 105, a candidate index term list creation unit 106, a text acquisition unit 107, a training set creation unit 108, a learning unit 109, and a for-use index term determination unit 110. In the description below, the processes executed by the above-mentioned processing units are actually executed by the control unit 101 according to programs stored in the storage unit 102.

The storage unit 102 is a storage device that stores programs for the control unit 101 to perform the processes, as well as data and the like that are referenced as the control unit 101 performs the processes, and may include a primary storage device such as a semiconductor memory and an external storage device such as a hard disk drive, for example. The storage unit 102 of the present embodiment stores, in addition to the above-mentioned programs (not shown), index term-related document group data 111, training set data 112, training set evaluation value data 113, and for-use index term data 114.

The input/output unit 103 has an input device such as a keyboard or a pointing device, for example, and an output device such as an image display device, for example. The communication unit 104 is an interface for communication of data with the document management server 120 through the network 130.

The document management server 120 is constituted of a control unit 121 and a storage unit 122, an input/output unit 123, and a communication unit 124 that are connected to the control unit 121.

The control unit 121 is a processor that executes various processes according to programs (not shown) stored in the memory 122. The control unit 121 of the present embodiment has a text search unit 125 and a text output unit 126. In the description below, the processes executed by the above-mentioned processing units are actually executed by the control unit 121 according to programs stored in the storage unit 122.

The storage unit 122 is a storage device that stores programs for the control unit 121 to perform the processes, as well as data and the like that are referenced as the control unit 121 performs the processes, and may include a primary storage device such as a semiconductor memory and an external storage device such as a hard disk drive, for example. The storage unit 122 of the present embodiment stores, in addition to the above-mentioned programs (not shown), a text storage table 127. The text storage table 127 of the document management server 120 stores a plurality of documents (e.g. literature, etc.) and one or more index terms assigned to each of the documents.

The input/output unit 123 has an input device such as a keyboard or a pointing device, for example, and an output device such as an image display device, for example. The communication unit 124 is an interface for communication of data with the training data expansion apparatus 100 through the network 130.

In the example of FIG. 1, the training data expansion apparatus 100 and the document management server 120 are realized by one computer each, but the functions of the training data expansion apparatus 100 and the document management server 120 may all be consolidated onto one computer or distributed among three or more computers.

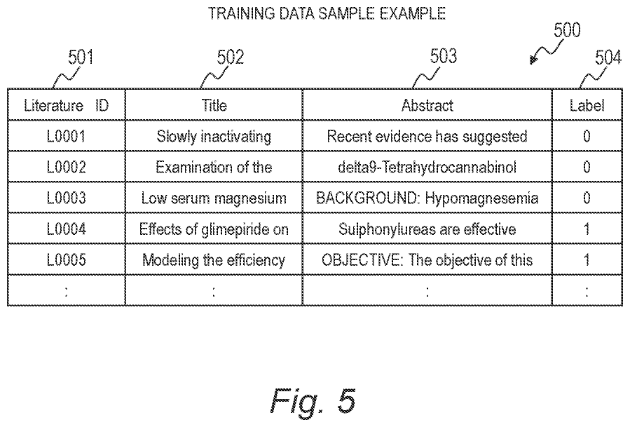

The input/output unit 103 reads the training data sample. The training data sample is a document group inputted as training data in order to create a document identification model, and includes information indicating whether each document is an applicable document or a non-applicable document (see FIG. 5 for details). A configuration may be adopted in which identifiers of document data to be included in the training data sample and information indicating whether each piece of document data is an applicable document or a non-applicable document are inputted to the input/output unit 103, and document data corresponding to the inputted identifier is acquired from the document management server 120 through the communication unit 104, and the information is stored in the storage unit 102, for example.

Here, applicable documents are documents that would be identified by the document identification model to be created (in other words, documents to be acquired as a result of identification using the document identification model), and non-applicable documents are other documents. If, for example, one were to create a document identification model for acquiring documents including information pertaining to a clinical trial of a certain drug, from among a plurality of documents (e.g. literature, etc.), then documents including information pertaining to clinical trials of the drug are applicable documents, and other documents are non-applicable documents.

The document index term acquisition unit 105 sends an identifier of the training data sample to the text search unit 125 through the input/output unit 123 of the document management server 120, thereby acquiring a document index term corresponding to the training data sample. The candidate index term list creation unit 106 aggregates index terms acquired for each document and compares applicable documents to non-applicable documents, thereby creating a candidate list of index terms for which to create the training data.

The text acquisition unit 107 searches a text storage table 127 for documents to which the index term is assigned, through the text search unit 125 of the document management server 120, with the index term as the search query, and acquires text through the text output unit 126. The acquired text is stored as the index term-related document group data 111 of the storage unit 102. The training set creation unit 108 uses data in which a prescribed number of index terms of the candidate index term list are acquired (randomly, for example), to create the training set. The created training set is stored as the training set data 112 of the storage unit 102.

The learning unit 109 learns by acquiring, through the text acquisition unit 107, a document group pertaining to the index term included in the training set. The control unit 101 identifies the training sample according to a document identifier attained as a result of learning, aggregates the results thereof, and stores the results as the training set evaluation value data 113 of the storage unit 102. The for-use index term determination unit 110 determines the index term to be used from a training set for which the result of evaluating the training set exceeds a prescribed threshold. The determined entry data for use is used when creating the training data for identifying documents.

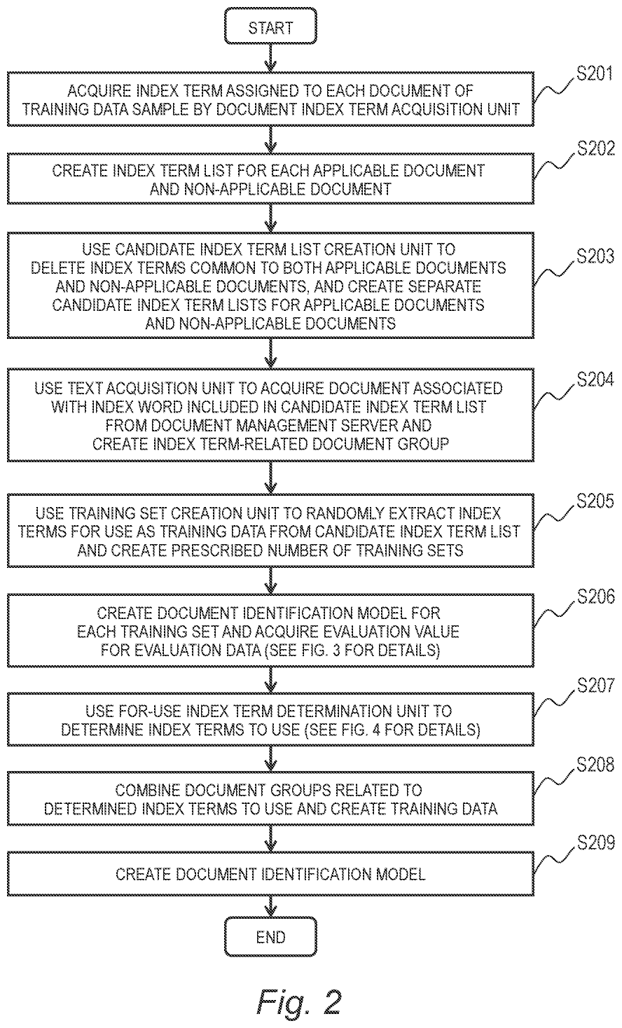

FIG. 2 is a flowchart showing a process executed by the training data expansion apparatus 100 according to an embodiment of the present invention. The process of the steps based on this flowchart is described below.

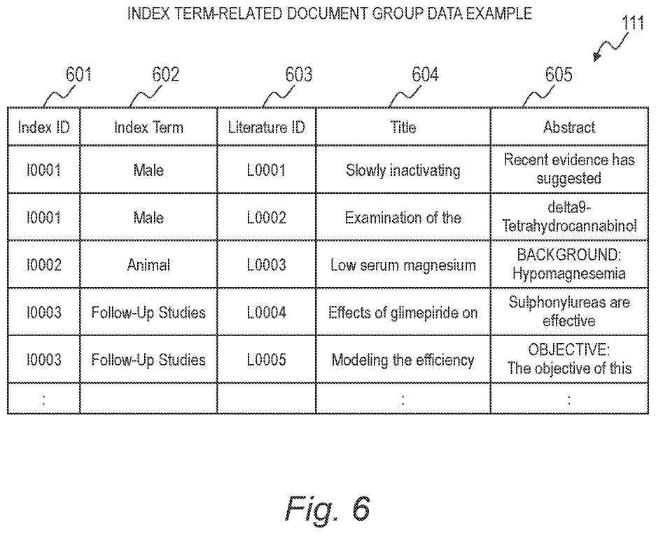

Step S201: the document index term acquisition unit 105 acquires index terms corresponding to each training data sample by reading identifiers of the training data sample acquired through the input/output unit 103. If the document is the biomedical publication PubMed, for example, a PMID, which is an identifier of PubMed, is handed over to an API provided by PubMed, and as a result, an index term referred to as a MeSH term corresponding to the PMID is attained. As a result, approximately 20 index terms per document are attained. FIG. 5 shows an example of a training data sample. By handing over the identifiers of the documents, it is possible to attain index terms for each document as shown in FIG. 6. According to FIG. 6, if an identifier L0001 of a document is inputted, for example, the index term “Male” can be acquired, and the identifier of the index term is I0001. Details regarding FIGS. 5 and 6 will be described later.

Step S202: the candidate index term list creation unit 106 aggregates index terms of the documents for each document included in the applicable document group and non-applicable document group, and creates an index term list indicating, for each index term, how many times the index term has appeared in documents (that is, the number of appearances).

Step S203: the candidate index term list creation unit 106 deletes index terms common to both the applicable documents and the non-applicable documents from among the index term lists created in step S202, in order to attain index terms unique to the applicable document group and the non-applicable document group, respectively, and creates candidate index term lists for the applicable documents and for the non-applicable documents. As a result, the training set to be mentioned later does not include index terms assigned both to the applicable documents and the non-applicable documents. In this process, the candidate index term list creation unit 106 may remove, from the index term list, index terms for which the number of appearances is less than a prescribed number (index terms that only appear once, for example).

Also, a configuration may be adopted in which the candidate index term list creation unit 106 generates, for each index term, an applicable document appearance ratio (appearance frequency of the index term in the applicable document group divided by the number of documents belonging to the applicable document group), and a non-applicable document appearance ratio (appearance frequency of the index term in the non-applicable document group divided by the number of documents belonging to the non-applicable document group), takes the ratio of the applicable document group appearance ratio and the non-applicable document group appearance ratio, and adds index terms for which the ratios differ to candidate index term lists for the respective document groups as unique index terms for the document groups. If, for a given index term, the applicable document appearance ratio is greater than the non-applicable document appearance ratio, for example, the index term may be added to the candidate index term list for applicable documents.

Step S204: the text acquisition unit 107 acquires documents corresponding to the index terms included in the candidate index term list from the document management server 120 and creates index term-related document group data 111 including the acquired documents.

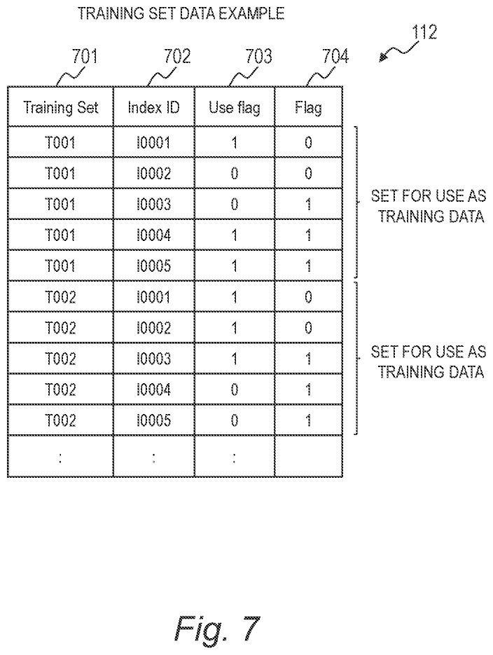

Step S205: the training set creation unit 108 randomly extracts one or more index terms used in the training data from the candidate index term list and creates a prescribed number of training sets. The training sets are recorded as data in the manner shown in FIG. 7 (described later), for example.

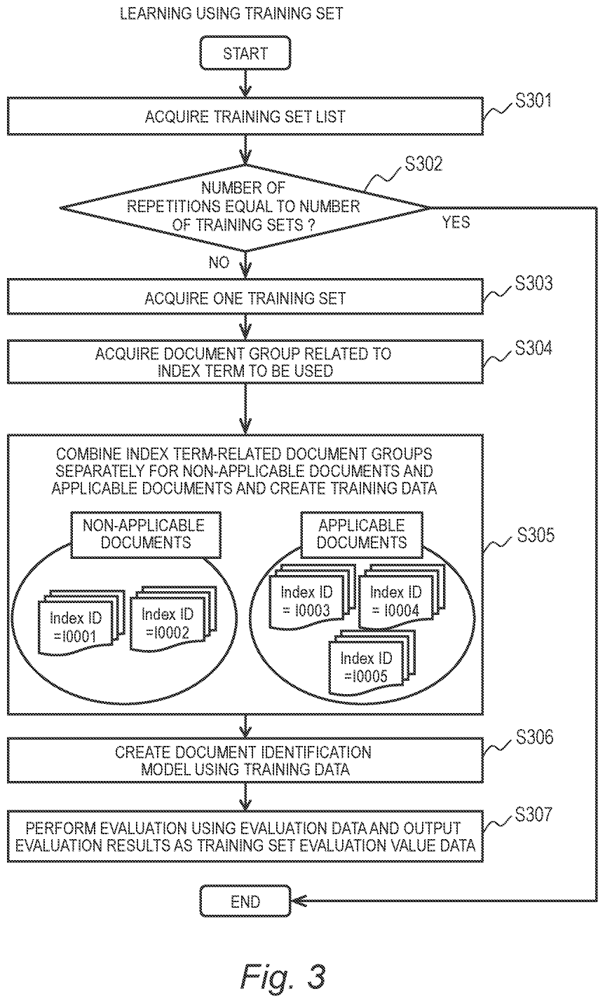

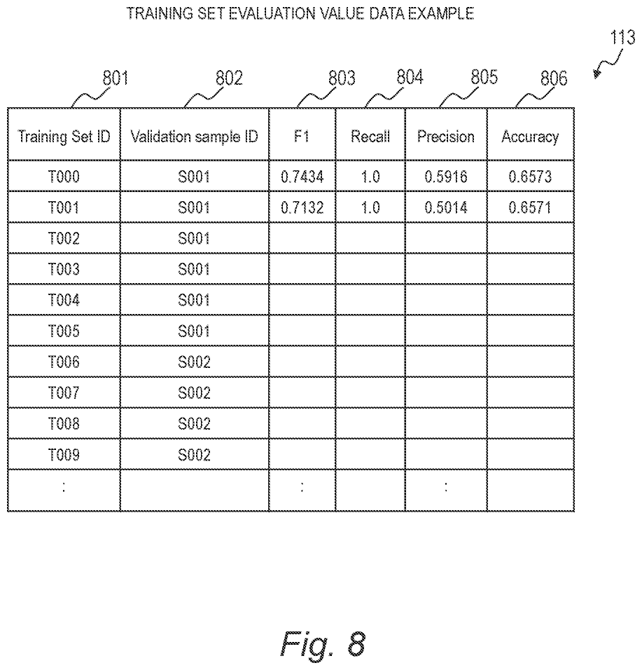

Step S206: the learning unit 109 creates a document identification model for each training set and acquires an evaluation value indicating the identification performance of the document identification model, for the evaluation data. FIG. 3 shows a detailed flow (described later). The evaluation value is stored as the training set evaluation value data 113 such as shown in FIG. 8, for example.

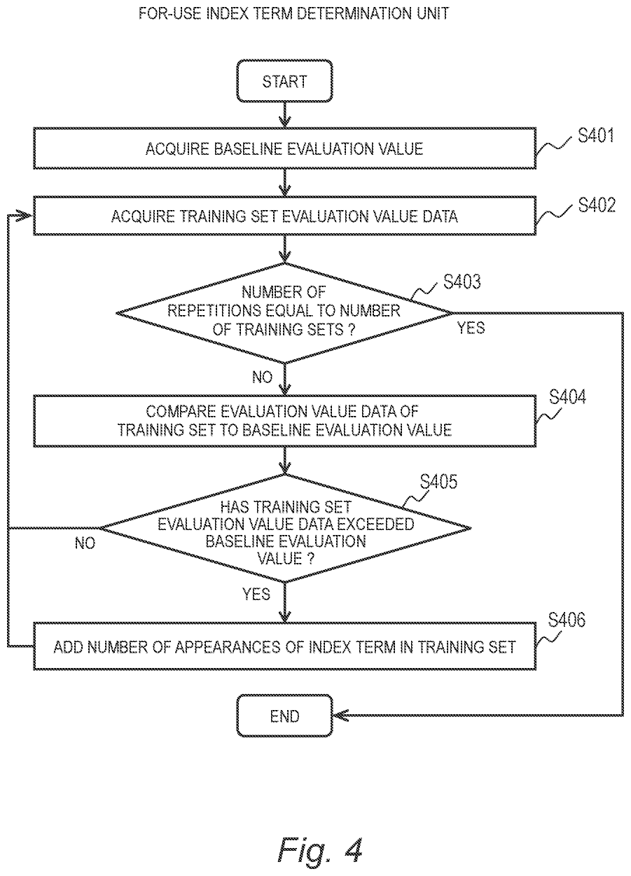

Step S207: the for-use index term determination unit 110 sets a baseline evaluation value, uses training sets having evaluation values that exceed this baseline, and determine an index term to be used for creating the training data. FIG. 4 shows a detailed flow (described later).

Step S208: the control unit 101 combines document groups related to the determined index terms to be used and creates the training data.

Step S209: the control unit 101 creates the document identification model by learning the training data created in step S208. As described above, training data that combines documents pertaining to the determined index terms to be used on the basis of the evaluation value is used, and thus, compared to a case in which only the training data sample is used, it is possible to create a better performance document identification model.

FIG. 3 is a flowchart showing a process in which the training data expansion apparatus 100 according to an embodiment of the present invention learns for each training set.

This process is part of a process to generate various combinations of index terms, performing evaluation by evaluation data according to those combinations, testing whether the evaluation values indicating the evaluation results exceed the baseline evaluation value, and determining the index term to be used as training data according to the results. The process based on the flowchart for the learning process using the training set is described below.

Step S301: the learning unit 109 acquires a training set list indicating combinations of index terms of documents included in the training data. Data such as the training set data of FIG. 7 is acquired, for example.

Step S302: the learning unit 109 repeats the process of steps 304 to 307 for all training sets included in the training set data. Thus, in step S302, the learning unit 109 determines whether the process of steps 304 to 307 has been repeated the same number of times as the number of training sets. The number of training sets is provided as a parameter. The training set data of FIG. 7 includes a number of training sets equal to the number of different identifiers (that is, unique identifiers appearing in the training set). The learning unit 109 sequentially reads identifiers of the training sets, and executes the process of steps S303 to S307 for training sets identified by the read identifiers. As of when all identifiers are read (that is, there are no more remaining identifiers to be read), the learning unit 109 determines that the process of steps 304 to 307 has been repeated a number of times equal to the number of training sets (S302: YES), and ends the process.

Step S303: the learning unit 109 acquires one training set identified using the identifier read in during step S302.

Step S304: the training set has a flag (use flag 703) indicating, for each index term, whether to use the index term. The learning unit 109 acquires data of the index term if the flag thereof is “use”. In the example of FIG. 7, within the training set identified by the identifier “T001”, the index terms identified by the identifiers “I0001”, “I0004”, and “I0005” have a use flag of 1. Thus, the learning unit 109 acquires, from the documents stored in the document management server 120, document groups pertaining to the index terms of “I0001”, “I0004”, and “I0005” (that is, the collection of documents to which the index terms are assigned).

Additionally, the learning unit 109 refers to the index term-related document group data 111 of FIG. 6 and acquires the title, abstract, and main text of documents pertaining to the identifiers “I0001”, “I0004”, and “I0005” for the index terms. The training set includes a flag (flag 704) indicating, for each index term, whether to use the training set as training data for non-applicable documents or to use the training set as training data for applicable documents. In the example of FIG. 7, documents pertaining to index terms assigned a flag 704 of “1” are used as training data for applicable documents, while documents pertaining to index terms assigned a flag 704 of “0” are used as training data for non-applicable documents.

Step S305: the learning unit 109 creates training data by combining index term-related document groups for the non-applicable documents and the applicable documents according to the flag, which is included in the training set data, indicating whether to use the documents as training data for the applicable documents. The training data created here differs from the final training data created in step S208 in FIG. 2, and is temporarily created for the process of determining whether to use each index term to create the final training data.

Step S306: the learning unit 109 creates the document identification model by learning using the created training data. The document identification model may be created by any method, including the use of a support vector machine (SVM), for example. This method involves searching for a characteristic word such as a noun or a verb stem from text in the document, expressing whether the characteristic word is included in the document as a 0 or 1, expressing by a vector the proportion that the characteristic word takes up among all words in the text of the document, and dividing a multi-dimensional characteristic vector group, which is a document group, into two categories by a hyperplane boundary. Besides this, a document identification method by deep learning such as shown in “Bag of Tricks for Efficient Text Classification (https://arxiv.org/abs/1607.01759)” may be employed.

Step S307: the learning unit 109 evaluates the document identification model by evaluation data that was created in advance and outputs the evaluation results as the training set evaluation value data 113. An example of outputted training set evaluation value data 113 will be described later with reference to FIG. 8.

Here, evaluation data is data created in advance in order to evaluate a created document identification model, and, similar to the initially used training data sample, includes a plurality of documents to which information indicating whether the documents are applicable documents or non-applicable documents is affixed. The evaluation data may be the same document group as the training data sample, for example, but it is preferable that the evaluation data be a different document group from the training data sample.

FIG. 4 is a flowchart showing a process by which the training data expansion apparatus 100 according to an embodiment of the present invention determines the index term to use.

The process based on this flowchart is described below. This process is a detailed version of step S207 of FIG. 2.

Step S401: the for-use index term determination unit 110 selects a plurality of index terms that can be reliably determined by a person to be index terms for non-applicable documents and a plurality of index terms that can be reliably determined to be index terms for applicable documents, creates training data based thereon, and creates a document identification model. At this time, the for-use index term determination unit 110 may create the document identification model using the document data used as the training data sample. The for-use index term determination unit 110 evaluates the model using evaluation data and attains results. Specifically, the for-use index term determination unit 110 uses the document identification model created as described above to identify whether each document included in the evaluation data is an applicable document or a non-applicable document, and evaluates the identification results by a prescribed method, thereby attaining evaluation results (evaluation value). The results are set as a baseline evaluation value. By using the evaluation value attained in this manner as a baseline, it is possible to create training data in which the evaluation value is reliably improved.

Step S402: the for-use index term determination unit 110 attains training set evaluation value data 113 from the storage unit 102. This data is created by the process shown in FIG. 3.

Step S403: the for-use index term determination unit 110 repeats the process of the following steps 404 to 406 the same number of times as the number of training sets. In step S403, if the process of steps 404 to 406 has not been repeated the same number of times as the number of training sets (step S403: NO), the for-use index term determination unit 110 executes the following steps 404 to 406 for the training sets that have not yet been processed. On the other hand, if the process of steps 404 to 406 has been repeated the same number of times as the number of training sets (step S403: YES), the process is ended.

Step S404: the for-use index term determination unit 110 compares the evaluation value data of the training set to the baseline evaluation value. If the value of F1 is used as the evaluation value, for example, if the baseline evaluation value is set to F1=0.72, then according to the evaluation value data for each training set in FIG. 8, the F1 value for the training set identifier “T000” is 0.7434, which exceeds the baseline, and the F1 value for the training set identifier “T001” is 0.7132, which is less than the baseline.

Step S405: that the evaluation value of the training set exceeds the baseline signifies that by adding the applicable documents and non-applicable documents extracted on the basis of the training set to the training data, it is possible to create a high accuracy document identification model. In other words, it is preferable that index terms used when the evaluation value exceeds the baseline be used to create the training data. Thus, the for-use index term determination unit 110 determines whether the evaluation value of the training set has exceeded the baseline evaluation value as a result of the comparison performed in step S404, and attains index terms used for training sets for which the evaluation value exceeds the baseline (that is, use flag=1).

Step S406: the for-use index term determination unit 110 adds (+1) the number of times the index term appears in the training set attained in S405, and attains index terms used frequently when the evaluation value exceeds the baseline.

The for-use index term determination unit 110 may determine that all index terms attained in S406 (that is, all index terms included in all training sets for which the evaluation value was determined in S405 to have exceeded the baseline evaluation value) should be used in order to create the final training data.

Alternatively, the for-use index term determination unit 110 may add index terms attained in S406 to baseline index terms and reevaluate the index terms, and determine that the index terms should be used only when the evaluation value increases. Specifically, for example, the for-use index term determination unit 110 adds, to training data including a training data sample, document data to which the index term is assigned in order of appearance frequency of the index term, creates a document identification model by learning the training data, and calculates the evaluation value thereof. If the evaluation value does not improve as a result (the calculated evaluation value is less than the baseline evaluation value, or is less than the previously calculated evaluation value, for example), then a determination may be made not to use the index term to create the training data. If the evaluation value improves, then the index term may be determined to be appropriate to use for creation of the training data, with the training data, to which the document data assigned the index term was added, having further added thereto document data assigned an index term with the next highest appearance frequency, and a similar process to what was described above may be repeated.

The for-use index term determination unit 110 writes the index term determined appropriate to use as for-use index term data 114.

Alternatively, the for-use index term determination unit 110 may determine that index terms for which the appearance frequency satisfies a prescribed condition (e.g. index terms for which the appearance frequency exceeds a prescribed reference value, or the index terms with top appearance frequencies) should be used to create the training data.

Alternatively, the for-use index term determination unit 110 may create a document identification model by training data where the evaluation value exceeds the baseline, create an ensemble of the identification results from the model, and output final identification results.

By creating training data by the above method, it is possible to create a sufficient quantity of training data useful for creating a model for identifying desired documents without increasing the workload on people.

FIG. 5 is a descriptive view showing a configuration example of a training data sample retained by the training data expansion apparatus 100 according to an embodiment of the present invention.

The training data sample includes an identifier 501 of the document, a title 502 that is the content of the document, an abstract 503, and a flag that indicates whether each document is an applicable document. On the basis of this data, data expansion is performed by the method shown in FIG. 2.

FIG. 6 is a descriptive view showing a configuration example of index term-related document group data 111 retained by the training data expansion apparatus 100 according to an embodiment of the present invention.

The index term-related document group data 111 includes an identifier 601 of the index term, the index term 602, an identifier 603 of the document to which the index term is assigned, a title 604 indicating the content of the document, an abstract 605, and the like.

FIG. 7 is a descriptive view showing a configuration example of training set data 112 retained by the training data expansion apparatus 100 according to an embodiment of the present invention.

The training set data 112 includes an identifier 701 of the training set, an identifier 702 of the index term, a use flag 703 indicating whether to include the index term in the training set, and a flag 704 indicating whether the document to which the index term is assigned should be handled as an applicable document or a non-applicable document. This data is generated as a result of the process of step S205 shown in FIG. 2. Also, the data is used in order to create the training data in step S206 as well.

FIG. 7 shows an example in which five index terms identified by identifiers “I0001” to “I0005” are extracted from the training data sample, and two training sets identified by the identifiers “T001” and “T002” are created on the basis of the index terms. As indicated by the values of the flag 704, the index terms “I0001” and “I0002” are assigned to non-applicable documents, and the index terms “I0003” to “I0005” are assigned to applicable documents.

In the example of FIG. 7, in the training set “T001”, the value of the use flag 703 is “0” for the index terms “I0002” and “I0003”, and the value of the use flag for the index terms “I0001”, “I0004”, and “I0005” is “1”. This indicates that the training set “T001” includes the index terms “I0001”, “I0004”, and “I0005” as index terms for extracting the document data to be used as training data.

On the other hand, in the training set “T002”, the value of the use flag 703 is “1” for the index terms “I0001” to “I0003”, and the value of the use flag for the index terms “I0004” and “I0005” is “0”. This indicates that the training set “T002” includes the index terms “I0001” to “I0003” as index terms for extracting the document data to be used as training data.

These training sets are created in step S205 shown in FIG. 2. In the example of FIG. 2, which index terms to include in each training set for extracting the document data to be used as training data is determined randomly. As a result, various combinations of index terms are generated, and useful index terms can be selected therefrom. However, this is only one example of a determination method, and index terms included in various training data may be determined on the basis of some rule instead of being determined randomly, for example.

In step S303 of FIG. 3, if the training set “T001” is acquired, then among document data other than the training data sample, a document group constituted of document data to which at least one of the index terms “I0001”, “I0004”, and “I0005” is assigned, is acquired (step S304). Among the document data, the document data assigned the index term “I0001” is included as non-applicable documents, and the document data assigned the index term “I0004” or “I0005” is included as applicable documents (step 305).

The document identification model is generated by learning the created training data (step S306), and an evaluation value of the generated document identification model is calculated (step S307).

If it is determined that the index terms “I0001” and “I0003” should be used for creating the training set on the basis of the calculated evaluation value (step S207 in FIG. 2), for example, the document data assigned the index term “I0001” among the document data other than the training data sample retained by the document management server 120 is added as training data for non-applicable documents, and document data assigned the index term “I0003” is added as training data for applicable documents (S208).

FIG. 8 is a descriptive view showing a configuration example of the training set evaluation value data 113 retained by the training data expansion apparatus 100 according to an embodiment of the present invention.

The training data expansion apparatus 100 includes an identifier 801 of the training set indicating which training set was used, an identifier 802 of evaluation data indicating which evaluation data was used, and one or more evaluation values indicating the evaluation results. In the example of FIG. 8, an F value (F1) 803, recall 804, precision 805, and accuracy 806 are included as evaluation values. These are merely examples of evaluation values and only some of these evaluation values or other evaluation values may be included. By using such evaluation values, it is possible to create training data that contributes to creating a document identification model with desired performance.

The present invention is not limited to the embodiments above, and includes various modification examples. The embodiments above were described in detail in order to explain the present invention in an easy to understand manner, but the present invention is not necessarily limited to including all configurations described, for example.

Some or all of the respective configurations, functions, processing units, processing means, and the like can be realized with hardware such as by designing an integrated circuit, for example. Additionally, the respective configurations, functions, and the like can be realized by software, by the processor interpreting programs that realize the respective functions and executing such programs. Programs, data, tables, files, and the like realizing respective functions can be stored in a storage device such as a non-volatile semiconductor memory, a hard disk drive, or a solid state drive (SSD), or in a computer-readable non-transitory data storage medium such as an IC card, an SD card, or a DVD.

Control lines and data lines regarded as necessary for explanation have been indicated, but not all control lines and data lines in the product have necessarily been indicated. In reality, almost all components can be thought of as connected to each other.

What is claimed is:

1. A training data creation method executed by a computer system having a processor and a storage unit,
wherein the storage unit stores a plurality of pieces of document data, each of which is assigned one or more index terms,
wherein some of the plurality of pieces of document data are training data samples provided in advance as training data to be used for generating a document identification model,
wherein the storage unit stores information indicating whether each piece of document data included in the training data sample is data of an applicable document that is subject to identification by the document identification model or a non-applicable document that is not subject to identification, and
wherein the training data creation method comprises:
a first step in which the processor creates a training set that includes, as an index term for extracting a document used for learning, one or more of the index terms assigned to the applicable documents and the index terms assigned to the non-applicable documents;
a second step in which the processor creates the document identification model that learns the document data assigned the index term included in the training set, among a plurality of pieces of document data aside from the training data sample;
a third step in which the processor uses the created document identification model and identifies evaluation data including the plurality of pieces of document data that are assigned in advance information indicating whether the document data is the applicable document or the non-applicable document, thereby creating an evaluation value of the created document identification model;
a fourth step in which the processor determines whether to use each index term included in the training set for creating the training data on the basis of the evaluation value; and
a fifth step in which the processor adds as the applicable document data, to the training data, document data that is assigned an index term of an applicable document determined to be appropriate for use in creating the training data, among the plurality of pieces of document data aside from the training data sample, and adds document data assigned an index term of a non-applicable document determined to be appropriate for use in creating the training data to the training data as the non-applicable document data, to create the training data.

2. The training data creation method according to claim 1,
wherein, in the first step, the processor creates a plurality of said training sets,
wherein, in the second step, the processor creates the document identification model for each of the plurality of training sets,
wherein, in the third step, the processor creates the evaluation value for each of the created document identification models, and
wherein, in the fourth step, the processor calculates an appearance frequency for each index term in the training set used to create the document identification model for which the evaluation value is greater than a prescribed standard, and determines that index terms with a high said appearance frequency should be used to create the training data.

3. The training data creation method according to claim 2,
wherein, in the fourth step, the processor adds the document data to which the index term was assigned to the training data in order from the highest appearance frequency, creates the document identification model using the training data, and if the evaluation value of the created document identification model does not improve, determines that the index term should not be used to create the training data.

4. The training data creation method according to claim 1,
wherein, in the fourth step, the processor determines that said one or more index terms included in the training set used to create the document identification model for which the evaluation value is greater than a prescribed standard should be used to create the training data.

5. The training data creation method according to claim 1,
wherein, in the fourth step, the processor determines that each index term included in the training set should be used for creating the training data if the evaluation value is greater than a prescribed standard, and
wherein the prescribed standard is the evaluation value of the document identification model created by learning the training data sample.

6. The training data creation method according to claim 1,
wherein the evaluation value includes at least one of an F value, recall, precision, and accuracy.

7. The training data creation method according to claim 1,
wherein, in the first step, the processor creates the training set including one or more of the index terms extracted randomly from among the index terms assigned to the applicable documents and the index terms assigned to the non-applicable documents.

8. The training data creation method according to claim 1,
wherein, in the first step, the processor creates the training set so as not to include index terms assigned to both the applicable documents and the non-applicable documents.

9. The training data creation method according to claim 1, further comprising:
a step in which, by the processor learning the training data created in the fifth step, the processor creates the document identification model for identifying whether the inputted document is the applicable document.

10. A training data creation apparatus, comprising:
a processor; and
a storage unit,
wherein the storage unit stores a plurality of pieces of document data, each of which is assigned one or more index terms,
wherein some of the plurality of pieces of document data are training data samples provided in advance as training data to be used for generating a document identification model,
wherein the storage unit stores information indicating whether each piece of document data included in the training data sample is data of an applicable document that is subject to identification by the document identification model or a non-applicable document that is not subject to identification, and
wherein the processor
creates a training set that includes, as an index term for extracting a document used for learning, one or more of the index terms assigned to the applicable documents and the index terms assigned to the non-applicable documents,
creates the document identification model that learns the document data assigned the index term included in the training set, among a plurality of pieces of document data aside from the training data sample,
uses the created document identification model and identifies evaluation data including the plurality of pieces of document data that are assigned in advance information indicating whether the document data is the applicable document or the non-applicable document, thereby creating an evaluation value of the created document identification model,
determines whether to use each index term included in the training set for creating the training data on the basis of the evaluation value, and
adds as the applicable document data, to the training data, document data that is assigned an index term of an applicable document determined to be appropriate for use in creating the training data, among the plurality of pieces of document data aside from the training data sample, and adds document data assigned an index term of a non-applicable document determined to be appropriate for use in creating the training data to the training data as the non-applicable document data, to create the training data.
